(19) United States
(12) Patent Application Publication
(10) Pub. No.: US 2006/0136239 A1
(43) Pub. Date: Jun. 22, 2006

(54) Method for recycling used items

(76) Inventors: Lloyd D. Kagan, Coconut Creek, FL (US); Steve B. Kagan, Coral Springs, FL (US)

Correspondence Address: BRINKLEY, MCNERNEY, MORGAN, SOLOMON;& TATUM, LLP, 19TH FLOOR, 200 EAST LAS OLAS BLVD., Fort Lauderdale, FL, 33301, US

(21) Appl. No.: 11/016,486

(22) Filed: Dec. 17, 2004

(51) Int. Cl. G06Q 99/00

(52) U.S. Cl. 705/1

(57) ABSTRACT

A method for recycling used items, such as automotive parts, includes a manufacturer and a network of service centers that are obligated to return defective, worn out, broken, or otherwise used components to a manufacturer/franchisor in exchange for warranty payment by the manufacturer. The used items are preferably received by the manufacturer without charge from the service centers under the service centers' obligation to return the components to the manufacturer instead of otherwise disposing of them. The manufacturer sells the returned components to a refurbisher. The refurbisher then refurbishes the items and sells them on the open market. The revenue received by the manufacturer from the sale of the returned components to the refurbisher is recognized as profit to the manufacturer or is used to offset the manufacturer's warranty costs. The method permits the manufacturer to realize previously unrecognized revenue on the processing of recycled goods.

### BACKGROUND OF THE INVENTION

1. Field of the Invention

The present invention relates generally to the recycling of used durable goods and, in particular, to a method for realizing a heretofore unrealized profit from the recycling and rebuilding of defective, worn out or otherwise used, refurbishable items, such as automotive parts. However, it is to be understood that the invention is not limited to the recycling and rebuilding of automotive parts, but will have application in any industry in which recycling and rebuilding of used parts and equipment is carried out or can be carried out.

2. Current Relevant Art

It is commonplace in various industries, especially the automotive industry, for defective, worn out, and/or otherwise used parts to be recycled for subsequent sale in an after market. Typically, rebuilt parts are sold at a price which is significantly lower than new parts supplied by the original equipment manufacturer (“OEM”). Consequently, there is a sizable market for rebuilt/recycled products due to their reduced cost to the consumer.

The description of the background art as well as the disclosure of the invention herein will be made, for purposes of example only, in the context of the recycling of used automotive equipment. However, it is to be understood that the scope of this invention is intended to encompass any recycling method and/or system in which rebuildable defective, worn out, and/or otherwise used goods can be recycled.

Presently, defective, worn out, and/or otherwise used automotive parts are acquired by entities that rebuild/refurbish such parts in two primary ways. First, such parts are acquired from entities commonly known as “core suppliers,” which themselves acquire the used parts from service centers, such as auto repair shops or service/parts departments of automotive dealerships, after the parts are removed from a host article, such as an automobile. The core suppliers are independent businesses that rely on their own particular resources to find and acquire various used parts. It is widely known in the automotive industry that a great deal of defective, worn out, and/or otherwise used parts do not ever get recycled. Instead, such parts are discarded, winding up in land fills, salvage yards, or industrial waste sites. Certain automotive manufacturers actually require their franchisees/dealers to permanently disable and/or destroy used parts so that they cannot be recycled.

The second primary way in which used parts are acquired by the rebuilders is through the use of so-called “core charges.” Core charges are fees added by rebuilders/refurbishers to the cost of rebuilt parts purchased by auto parts stores or service centers. Each core charge acts as an incentive for an auto parts store or a service center to supply rebuilders with defective, refurbishable parts. When a used part is returned to a rebuilder, the core charge is refunded by the rebuilder to the parts store or service center. Refunding of the core charge provides a monetary incentive for parts stores and service centers to provide a continual supply of refurbishable parts to the rebuilders. Various permutations of the core charge concept are practiced throughout the automotive industry and, in some instances, the core charges are even passed on to the consumer as incentives for the consumer to return the used part to the retailer. Surprisingly, a significant percentage of core charges are never refunded because the “cores,” that is, the used parts, are never returned to the retailer or the rebuilder.

It is also common in the automotive industry for auto service centers to remove defective or broken components that are still under an OEM's warranty and return the components to the OEM for failure analysis purposes. In such cases, the OEMs analyze the defective components and attempt to determine the causes of the failures. Once failure analysis is complete, the defective components are simply discarded.

U.S. Pat. No. 6,609,050 B2 discloses a vehicle warranty and repair computer system. The disclosed system includes a dialog box that displays special messages to the service associate. One such message may be an indication that drive shaft or other parts are to be returned to the vehicle's manufacturer after servicing of the vehicle has been performed. However, that message is isolated and not part of a comprehensive recycling system.

U.S. Patent Application Publication No. US 2004/0034566 A1 discloses a system and method for utilizing recycled parts when a vehicle is repaired. The disclosed system includes a used car distribution system in which a registrant (e.g., service center) stores information about the used car in a main server. A dismantler/parts supplier accesses the stored information, purchases the used car based on the stored information, dismantles the car, and stores information on the used car parts in a “recycled parts” database. A rebuilder accesses the recycled parts database, purchases the used parts, rebuilds them and stores data regarding the rebuilt parts in the recycled parts database. A user of the rebuilt parts accesses the recycled parts database and orders the rebuilt parts from the re-builder.

U.S. Patent Application Publication No. US 2003/0120677 A1 discloses a closed loop asset management system. The disclosed system requires defective parts to be returned to a logical asset management network and process depot. The logical asset management network and process depot ships the defective parts to a warehouse, which in turn repairs the parts or sends them to an offsite repair facility. The repaired parts are returned to the warehouse, bar coded and replaced in inventory.

Although certain of these references separately disclose the broad concepts of returning defective parts to a vehicle manufacturer and of purchasing defective parts by a rebuilder, the references do not disclose or suggest a comprehensive recycling process involving the vehicle manufacturer.

Therefore, a need exists for a recycling method that provides incentives to manufacturers, service centers, and refurbishers to recycle certain defective, broken, worn out, or otherwise used items to the benefit of the environment and to the financial benefit of those involved. Such a method that eliminates or mitigates the need for core supplies would be a further improvement over the prior art.

### SUMMARY OF THE INVENTION

Therefore, it is one object of the present invention to provide a method for recycling defective, worn out, or otherwise used goods in which a service or repair center (e.g., an automotive dealership or an auto repair shop) returns a used item to a manufacturer or its designee, which item may or may not be under warranty, in exchange for consideration by the manufacturer (e.g., warranty payment for acquisition and installation of a replacement component), and the manufacturer provides the used component to a refurbisher/rebuilder in exchange for consideration (e.g., money) from the refurbisher/rebuilder.

It is also an object of this invention to provide a means for OEMs to recognize profit from the recycling of the OEMs' defective, worn out, or otherwise used components.

It is further an object of this invention to provide a method by which service/repair centers are incentivized or required to recycle defective, worn out, or otherwise used goods in lieu of discarding such items.

It is a still further object of this invention to provide a method whereby defective, worn out, or otherwise used goods are recycled instead of being discarded.

To solve the problems described above and to realize the objects of this invention, the present invention is comprised of a method and system for recycling defective, worn out, or otherwise used components, such as, by way of example, automotive parts, wherein a network of service/repair centers (“service centers”) (e.g., service/parts departments of automotive dealerships or independent automotive repair facilities) return defective, worn out or otherwise used components to a manufacturer in exchange for consideration (e.g., warranty payment by the manufacturer). The manufacturer in turn sells the returned components to a refurbisher. The refurbisher then refurbishes or rebuilds the components, and sells them on the open market. The revenue received by the manufacturer from the sale of the returned components to the refurbisher is recognized as profit by the manufacturer or is used to offset the manufacturer's warranty costs since the returned items were preferably received without independent cost from the service repair center. In one particular embodiment, in order to receive warranty payment from the manufacturer for replacing a warranted, refurbishable or recyclable item, the service centers are contractually obligated to return the warranted item to the manufacturer or its designee, at no cost or a nominal cost to the manufacturer, instead of otherwise disposing of the item. In another embodiment, in order to receive warranty payment from the manufacturer for replacing or otherwise servicing any particular warranted item, the service centers are contractually obligated to return to the manufacturer or its designee all warranted or non-warranted, refurbishable or recyclable items originally distributed by the manufacturer which are received from customers or are removed during servicing of host articles distributed by the manufacturer, instead of otherwise disposing of the items.

In yet another embodiment, the chain of custody of the defective, worn out, or otherwise used parts (hereinafter sometimes collectively referred to as “recyclable parts”) need not pass through the OEM. Rather, the recyclable parts may be acquired directly by the rebuilder/refurbisher and, in connection therewith, the rebuilder/refurbisher pays the OEM consideration for the parts, whereupon the recyclable parts are rebuilt/refurbished (hereinafter “recycled parts”) and placed back into the market as used parts. Thereafter, there may or may not be a core charge associated with the recycled parts.

### BRIEF DESCRIPTION OF THE DRAWINGS

FIG. 1 is a block diagram of a system for recycling used items in accordance with the present invention.

FIG. 2 is a flow diagram of steps executed by a manufacturer to recycle used items in accordance with a preferred embodiment of the present invention.

FIG. 3 is a flow diagram of steps executed by a service center to recycle used items in accordance with a preferred embodiment of the present invention.

FIG. 4 is a flow diagram of steps executed by a refurbisher to recycle used items in accordance with a preferred embodiment of the present invention.

FIG. 5 is a flow diagram of steps executed by a manufacturer to recycle used items in accordance with an alternative embodiment of the present invention.

FIG. 6 is a flow diagram of steps executed by a service center to recycle used items in accordance with an alternative embodiment of the present invention.

FIG. 7 is a flow diagram of steps executed by a refurbisher to recycle used items in accordance with an alternative embodiment of the present invention.

### DETAILED DESCRIPTION OF A PREFERRED EMBODIMENT

Generally, the present invention encompasses a method for recycling used items that requires the items to be returned to the manufacturer or other source of them prior to refurbishment. In accordance with the present invention, a used item extracted from a durable good, such as an automobile, is returned to the manufacturer of the good (e.g., the automobile OEM) in exchange for some consideration, such as a warranty payment. The manufacturer then provides the used item to a refurbisher in exchange for consideration, such as monetary compensation. The money received by the manufacturer is profit to the manufacturer or may be alternatively used to offset warranty costs. The refurbisher rebuilds, refurbishes or otherwise fixes the used item and then resells it to a bona fide purchaser for value, such as a service center, salvage yard, or retail store. The manufacturer preferably insures that it receives every refurbishable or recyclable item, or at least every refurbishable item for which there is a resale market, removed from goods or articles manufactured by it by contractually requiring service centers to supply such items to the manufacturer in order to receive warranty payment for parts and labor expended in removing the used item from the article and replacing the used item with a replacement (new or refurbished) item. Alternatively, if the manufacturer does not want to be directly involved in the actual flow of the used items, the service center may provide the used item to the refurbisher, and the manufacturer may require the service center or the refurbisher to pay the manufacturer a mutually agreed upon or predetermined amount for each recyclable item provided by the service center to the refurbisher.

By recycling used items in this manner, the present invention provides a system in which recycling is highly encouraged or required by the manufacturer in order for a service center to receive warranty payment. In addition, the manufacturer receives payment or other consideration for the used item in order to increase the manufacturer's profit or offset the manufacturer's warranty costs.

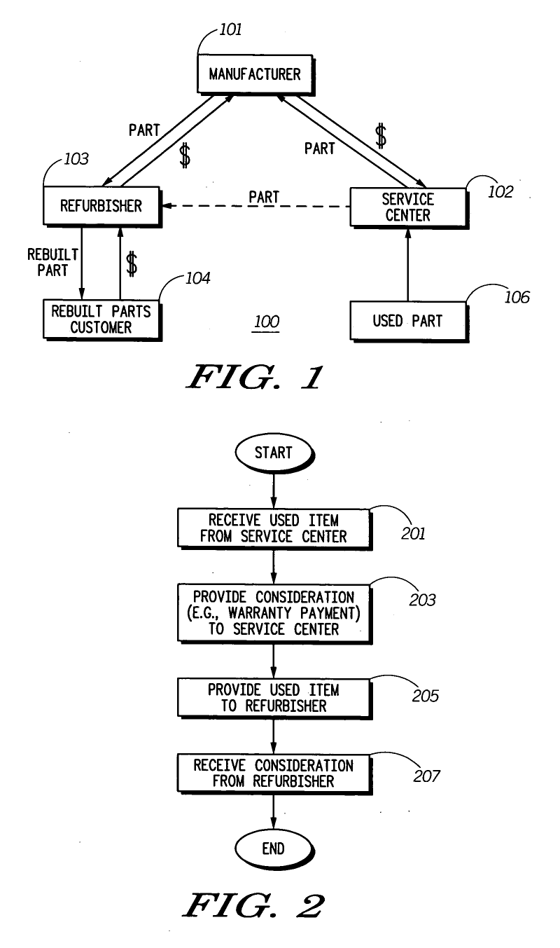

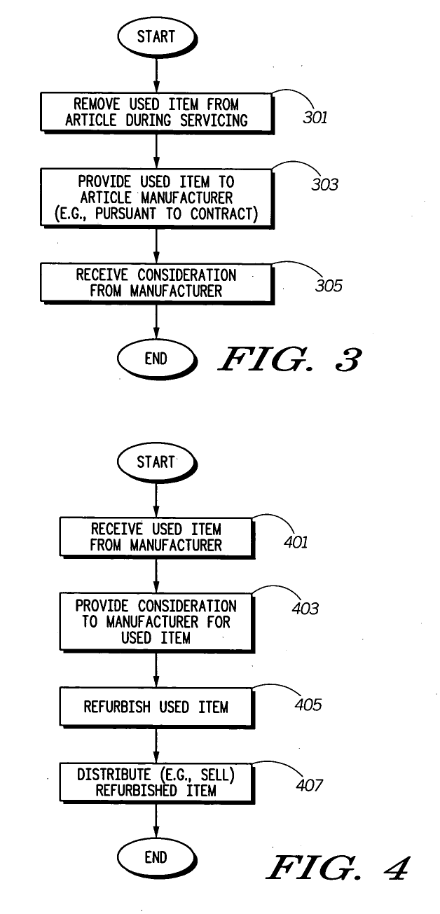

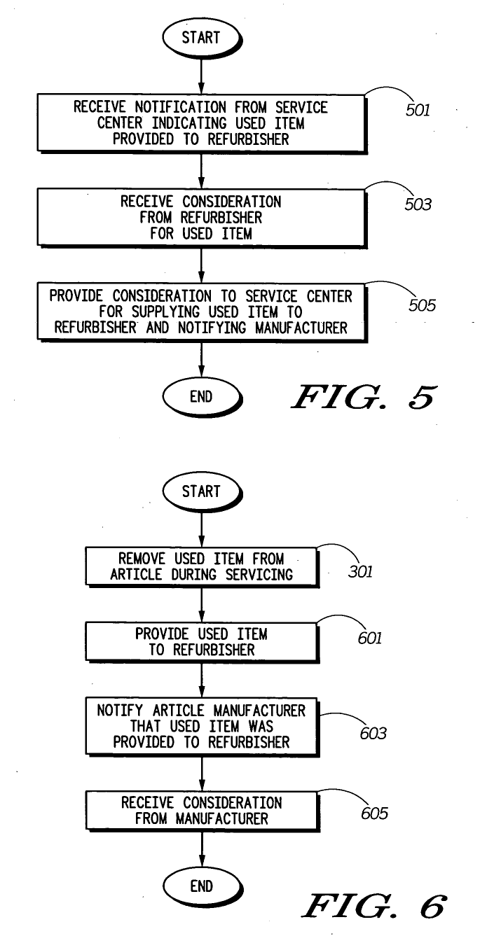

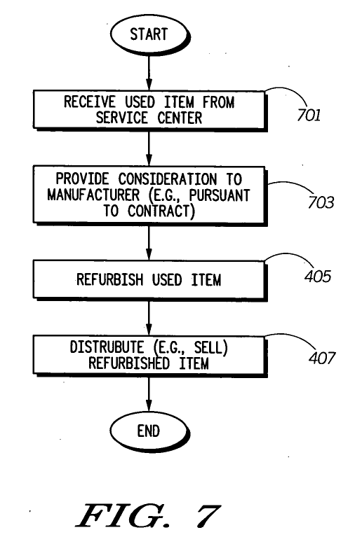

The present invention can be more fully understood with reference to FIGS. 1-7, in which like reference numerals designate like items. FIG. 1 is a block diagram of a system 100 for recycling used items in accordance with the present invention. The system 100 includes a manufacturer 101, a service/repair center 102, a refurbisher 103, and a rebuilt parts customer 104. In accordance with the present invention, the flow of recyclable, used items 106 from the service center 102 to the manufacturer 101 to the refurbisher 103 may be direct or indirect. Therefore, as used herein, the term “manufacturer” 101 means a producer or distributor (e.g., a franchisor) of the original item or part that has become used, an OEM or other producer of the article (e.g., automobile, boat, motorcycle, television, computer, and so forth) from which the used item 106 was removed, and/or any entity controlled by, under common control with, controlling, affiliated with, or under contract with the manufacturer 101 through which the manufacturer 101 obtains refurbishable or recyclable, used parts or other items and/or sells or distributes refurbished or recycled items. In addition, the term “service center” 102 means the entity that services or repairs the used item 106 or the article from which the used item 106 is removed, or any entity controlled by, under common control with, controlling, affiliated with, or under contract with the service center 102 through which the service center 102 provides the used item 106 to the manufacturer 101 or the refurbisher 103 in exchange for consideration (e.g., warranty payment) from the manufacturer 101. Finally, the term “refurbisher” 103 means the entity that refurbishes, rebuilds or repairs the used item 106 or any entity controlled by, under common control with, controlling, affiliated with, or under contract with the refurbisher 103 through which the refurbisher 103 acquires or refurbishes the used item 106, or distributes the refurbished item.

Operation of the recycling system 100 in accordance with a preferred embodiment of the present invention may be more fully understood with reference to FIGS. 1-4. In the preferred embodiment, the service center 102 services an article (not shown), such as a car, truck, boat, recreational vehicle (RV), snowmobile, motorcycle, television, stereo receiver, or any other device that includes recyclable components or parts, and removes (301) a recyclable or refurbishable, used item (e.g., an automotive or other component) from the article. When the article serviced is an automobile, the service center 102 may be an independent automotive repair facility or the service/parts department of an automotive dealership. When the entire article is refurbishable or recyclable, the “item” referred to above may be the entire article for purposes of the present invention, and removal (301) of the item by the service center 102 may simply comprise receiving the article from a customer.

Preferably, although not necessarily, pursuant to a contractual arrangement with the manufacturer 101 of the article or the item 106, the service center 102 provides (201, 303) the used item 106 to the manufacturer 101 and, in at least partial exchange, receives (203, 305) consideration from the manufacturer 101. When the used part 106 or the article from which the part 106 was removed is still under a warranty offered by the manufacturer 101, the consideration paid by the manufacturer 101 to the service center 102 preferably comprises some or all of the warranty payment necessary to reimburse the service center 102 for its parts and labor costs associated with procuring a replacement part (new or refurbished) and servicing the article (including replacing the defective or worn out item 106 with the replacement part). That is, in the preferred embodiment, no formal compensation is provided for the used item 106 itself, rather warranty payment for the service center's servicing of the article (e.g., automobile) is conditioned upon the manufacturer's receipt of the used item 106. Thus, pursuant to the present invention, the consideration provided (203) to the service center 102 by the manufacturer 101 is preferably conditioned on the service center's compliance with several obligations, including servicing the article or used item 106 and providing (303) the used item 106 to the manufacturer 101.

Payment by the manufacturer 101 may be immediate or may be delayed by a certain time period as set forth in the contractual arrangement between the manufacturer 101 and the service center 102. Alternatively, the consideration provided by the manufacturer 101 may be in any form as mutually agreed upon by the manufacturer 101 and the service center 102, although monetary compensation of the warranty payment is the preferred form of consideration provided to the service center 102.

In an alternative embodiment, the contractual arrangement between the manufacturer 101 and the service center 102 may provide that consideration will be provided to the service center 102 only if the removed, used item 106 is replaced with a replacement item (e.g., warranty service has been completed) and the used item 106 is returned to the manufacturer 101 at nominal or no cost to the manufacturer 101, thereby eliminating the service center's ability to mark-up or apply a core charge to the used item 106. Further, the contractual arrangement between the manufacturer 101 and the service center 102 may additionally or alternatively provide that consideration will be provided to the service center 102 only if the removed, used item 106 is replaced with a replacement item and all used items removed from articles manufactured by the manufacturer 101 are returned to the manufacturer 101 at nominal or no cost to the manufacturer 101 (e.g., during a predetermined time period, such as a month or a calendar quarter). By conditioning payment of consideration on receipt of the used item 106, the manufacturer 101 provides a great incentive to the service center 102 to supply the manufacturer with the used items 106.

After receiving (201) the used item 106 from the service center 102, the manufacturer 101 preferably sells or otherwise provides (205, 401) the used item 106 to the refurbisher 103. In exchange for receiving (401) the used item 106 from the manufacturer 101, the refurbisher 103 provides (207, 403) consideration to the manufacturer in exchange for the used item 106. The consideration can be in any form, but preferably comprises monetary compensation. In addition, the consideration may be paid immediately or at a later time pursuant to a contractual arrangement between the manufacturer 101 and the refurbisher 103.

After receiving (401) the used item 106 from the manufacturer 101, the refurbisher 103 refurbishes, rebuilds, or otherwise repairs (405) the used item 106 and sells or otherwise distributes (407) the refurbished item to an appropriate customer 104 (e.g., a service center). Once the refurbished item is in the hands of the new owner, the used item 106 has completed its recycling process.

Operation of the recycling system 100 in accordance with an alternative embodiment may be more fully understood with reference to FIGS. 1 and 5-7. In the alternative embodiment, instead of supplying the used item 106 to the manufacturer 101 after removing (301) the item 106 from the article, the service center 102 provides (601, 701) the used item 106 to the refurbisher 103 (as indicated by the dashed “PART” line in FIG. 1) and notifies (501, 603) the manufacturer 101. The notification may be in any form and may be made after each conveyance or in regular intervals (e.g., monthly or quarterly). For example, when notifications are made in intervals, each notification preferably indicates all used items that were removed from articles originally manufactured or supplied by the manufacturer and that were provided to refurbishers. Some time after receiving the notification from the service center 102, the manufacturer 101 provides (505, 605) consideration to the service center 102 in connection with its completion of warranty services, supply of the used item 106 to the refurbisher 103, and notification to the manufacturer 101. The consideration preferably comprises payment for parts and labor associated with the service center's completion of the warranty service (e.g., procurement and installation of a replacement item), but may include other benefits as well, such as, by way of example only, discounts on new articles (e.g., where the service center is the service department of an automobile dealership that purchases new automobiles from the manufacturer) or manufacturer-subsidized advertising.

After receiving (701) the used item 106 from the service center, the refurbisher 103 provides (503, 703) consideration to the manufacturer 101 pursuant to a contractual arrangement between the refurbisher 103 and either the manufacturer 101 or the service center 102. The refurbisher 103 then refurbishes, rebuilds, or otherwise repairs (405) the used item 106 and sells or otherwise distributes (407) the refurbished item to an appropriate customer 104. In this embodiment, the used item does not flow through the manufacturer 101; however, the manufacturer 101 still receives revenue from the refurbisher 103 for permitting recycling of the used item 106.

The present invention encompasses a method for recycling used items in which the manufacturer of a durable good or article from which a recyclable, used item is removed receives the used item and serves as the middleman or core broker in the recycling process or, alternatively, receives payment from a refurbisher after the service center that removed the used item provides such item to the refurbisher and notifies the manufacturer. With this invention, recycling of used items is increased because all key parties in the recycling process flow—the manufacturer, the service center, and the refurbisher—receive adequate incentives to justify and encourage recycling of used items. In contrast to prior art systems, no independent core brokers are necessary because the manufacturer or its designee directly or indirectly controls the flow of the used item in the recycling process. In addition, in accordance with the present invention, the manufacturer receives consideration (e.g., revenue) for the used item, which consideration can be used to increase the manufacturer's profits or offset its warranty costs. Such revenue on recycled goods has heretofore gone unrecognized by the manufacturer.

In the foregoing specification, the present invention has been described with reference to specific embodiments. However, one of ordinary skill in the art will appreciate that various modifications and changes may be made without departing from the spirit and scope of the present invention as set forth in the appended claims. For example, consideration may be provided to the manufacturer 101 or to the service center 102 in forms other than monetary compensation. In addition, intermediary entities may provide the actual interfaces between the manufacturer 101, the service center 102, and the refurbisher 103. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. As used herein and in the appended claims, the terms “comprises,” “comprising” or any other variation thereof is intended to refer to a non-exclusive inclusion, such that a process, method, apparatus, or article of manufacture that comprises a list of elements does not include only those elements in the list, but may include other elements not expressly listed or inherent to such process, method, apparatus, or article of manufacture. All terms used in the appended claims that are not otherwise specifically defined herein should be accorded their ordinary meanings.

1. A method for an article manufacturer to recycle used items forming at least part of an article, the method comprising:
receiving a used item from a service center pursuant to a contractual arrangement between the service center and the article manufacturer; and
providing the used item to a refurbisher in exchange for consideration, the refurbisher facilitating refurbishment of the used item.

2. The method of claim 1, further comprising:
after receiving the used item, providing second consideration to the service center.

3. The method of claim 2, wherein the used item is an item still under warranty and wherein the second consideration provided to the service center includes payment for parts and labor associated with replacing the used item with a replacement item.

4. The method of claim 3, wherein the contractual arrangement conditions payment for parts and labor associated with replacing the used item on receipt of the used item from the service center.

5. The method of claim 1, wherein the used item is an automotive component.

6. The method of claim 5, wherein the service center is one of an independent automotive repair facility and an automotive dealership.

7. A method for recycling used items, the method comprising:
receiving a used item from a manufacturer, the manufacturer having acquired the used item from a service center pursuant to a contractual arrangement between the manufacturer and the service center;
providing consideration to the manufacturer in exchange for the used item;
refurbishing the used item to produce a refurbished item; and
distributing the refurbished item.

8. The method of claim 7, wherein the used item is an item still under a warranty offered by the manufacturer.

9. The method of claim 7, wherein the used item is an automotive component.

10. The method of claim 7, wherein the manufacturer is a manufacturer of the item or an article from which the used item was removed.

11. A method for recycling used items, the method comprising:
receiving a used item from a service center, the used item forming at least part of an article;
providing consideration to at least a manufacturer of the article in exchange for the used item;
refurbishing the used item to produce a refurbished item; and
distributing the refurbished item.

12. A method for recycling used items, the method comprising:
removing a used item from an article during servicing of the article, the used item forming at least part of the article;
providing the used item to a manufacturer of the article pursuant to a contractual arrangement with the manufacturer; and
receiving consideration from the manufacturer at least partially in exchange for delivery of the used item.

13. The method of claim 12, wherein the article is an automobile and wherein the used item is an automotive component.

14. The method of claim 12, wherein the used item is an item covered by a warranty issued by the manufacturer and wherein the consideration received from the manufacturer includes payment for parts and labor associated with replacing the used item with a replacement item.

15. The method of claim 12, wherein the contractual arrangement generally provides that consideration will be provided by the manufacturer only if the used item is returned to the manufacturer.

16. The method of claim 12, wherein the contractual arrangement generally provides that consideration will be provided by the manufacturer only if the used item is replaced with a replacement item and the used item is returned to the manufacturer at nominal or no cost to the manufacturer.

17. The method of claim 12, wherein the contractual arrangement generally provides that consideration will be provided by the manufacturer only if the used item is replaced with a replacement item and all used items removed from articles manufactured by the manufacturer are returned to the manufacturer at nominal or no cost to the manufacturer.

18. A method for recycling used items, the method comprising:
providing a used item to a refurbisher, the used item forming at least part of an article, the refurbisher facilitating refurbishment of the used item;
notifying a manufacturer of the article that the used item was provided to the refurbisher; and
receiving consideration from the manufacturer at least partially in exchange for delivery of the used item to the refurbisher and providing notice thereof to the manufacturer.

19. The method of claim 18, wherein the used item is an item covered by a warranty issued by the manufacturer and wherein the consideration received from the manufacturer includes payment for parts and labor associated with replacing the used item with a replacement item.

20. The method of claim 18, wherein the article is an automobile and wherein the used item is an automotive component.

21. A method for a manufacturer to receive revenue resulting from recycling of used items, the method comprising:
receiving notification from a service center indicating that the service center provided at least one used item to a refurbisher, the used item forming at least part of an article distributed by the manufacturer, the refurbisher facilitating refurbishment of the used item; and
receiving consideration from the refurbisher at least partially in exchange for receipt of the used item from the service center.

22. The method of claim 21, further comprising:
after receiving the notification, providing second consideration to the service center.

23. A method for recycling used items, the method comprising:
removing, by a service center, a used item from an article during servicing of the article;
providing, by the service center, the used item to a manufacturer of the article pursuant to a contractual arrangement;
after receiving the used item from the service center, providing, by the manufacturer, first consideration to the service center in accordance with the contractual arrangement;
providing, by the manufacturer, the used item to a refurbisher;
providing, by the refurbisher, second consideration to the manufacturer in exchange for the used item;
refurbishing, by the refurbisher, the used item to produce a refurbished item; and
selling, by the refurbisher, the refurbished item.

24. The method of claim 23, wherein the article is an automobile, wherein the used item is an automotive component that is still under a warranty provided by the manufacturer, wherein the service center is one of an independent automotive repair facility and an automotive dealership, and wherein the step of providing first consideration to the service center in accordance with the contractual arrangement comprises:
after receiving the used item from the service center, providing, by the manufacturer, payment to the service center for parts and labor associated with replacing the used item with a replacement item.
